(19) United States
(12) Patent Application Publication
(10) Pub. No.: US 2014/0161411 A1
(43) Pub. Date: Jun. 12, 2014

(54) SURFACE-MOUNTABLE ENCLOSURE

(71) Applicants: Brett Hoe Slater, Mount Colah, NSW (AU); Bryce Lindsay Nicholls, Green Point, NSW (AU)

(72) Inventors: Brett Hoe Slater, Mount Colah, NSW (AU); Bryce Lindsay Nicholls, Green Point, NSW (AU)

(73) Assignee: TYCO ELECTRONICS SERVICES GMBH, Schaffhausen (CH)

(21) Appl. No.: 14/235,368

(22) PCT Filed: Jul. 26, 2012
(86) PCT No.: PCT/EP2012/064676

§ 371 Date: Jan. 27, 2014

(30) Foreign Application Priority Data
Jul. 27, 2011 (AU) 2011205016

(51) Int. Cl. G02B 6/44

(52) U.S. Cl. CPC G02B 6/4471
USPC 385/135; 242/598.6

(57) ABSTRACT

There is disclosed a surface-mountable enclosure (100) for use with a fibre optic cable (200), the cable (200) being terminated at one end by a subscriber end connector (202) and at the other end by a carrier end connector (204), the surface-mountable enclosure (100) including: a base (110); a spool member (130) which is mountable to the base (110) for rotation relative thereto; and a lid (150) which is fastenable to the base to enclose the spool member (130); wherein the spool member (130) includes a drum portion (131) with an annular sidewall (132) for spooling the cable (200). Also disclosed are a kit of parts for a surface-mountable enclosure, and an extension spool (170) for use with a surface-mountable enclosure.

### FIELD OF THE INVENTION

The present invention relates to surface-mountable enclosures, and to parts and accessories for use with such enclosures.

### BACKGROUND

It is becoming increasingly common for telecommunications networks to include a fibre optic component. Large scale fibre optic networks employing Fibre to the Node (FTTN) or Fibre to the Home (FTTH) architectures, for example, are either already deployed or in the planning stage in a number of countries.

If an office building or apartment block, for example, is to be connected to a fibre optic network, it is usual for there to be a fibre distribution hub to which individual offices or apartments are connected. This requires fibre optic cable to be run from the hub to an access point, such as a surface-mounted enclosure, within an office or apartment, to enable subscribers to connect.

A problem faced by cabling installers is that they do not necessarily know in advance the length of fibre which will be needed to interconnect a subscriber with the hub. A further problem is that the most suitable placement of an access point may be difficult to decide in advance.

There is a need, therefore, for a surface-mountable enclosure which provides more flexibility for the cabling installer.

### SUMMARY OF THE INVENTION

In accordance with one aspect of the invention, there is provided a surface-mountable enclosure for use with a fibre optic cable, the cable being terminated at one end by a subscriber end connector and at the other end by a carrier end connector, the surface-mountable enclosure including:

a base;
a spool member which is mountable to the base for rotation relative thereto; and
a lid which is fastenable to the base to enclose the spool member;
wherein the spool member includes a drum portion with an annular sidewall for spooling the cable.

Provision of a spool member within the enclosure allows pre-terminated cables of fixed length, wound on the spool, to be provided to the installer, so that cable can simply be unspooled to the needed extent once the installer is on-site. This simplifies preparation for installing a large number of access points, since the installer need simply obtain the appropriate number of pre-terminated and pre-spooled cables and enclosures before commencing work.

Preferably, the base includes a plurality of cable outlets, the carrier end connector being extractable to unspool a desired length of cable from the drum portion via one of the cable outlets.

Greater flexibility is afforded the installer by the provision of a plurality of cable outlets. In a particularly preferred embodiment, the plurality of cable outlets faces in at least two different directions for unspooling the desired length of cable in one of the at least two different directions. In this embodiment, fibre can be run in at least two different directions, for example in two different directions along a wall, or in one direction along a wall and a second direction into a wall cavity behind the enclosure. This provides greater freedom to choose the placement of the enclosure on a wall.

In one embodiment, the plurality of cable outlets includes a plurality of wall-side cable outlets facing in at least two different directions to allow the cable to be directed in one of the at least two different directions. Preferably, the wall-side cable outlets face in four different directions.

The plurality of cable outlets may also include a plurality of wall cavity cable outlets to allow the cable to be directed behind the enclosure and into a wall cavity. The wall cavity cable outlets are preferably in close proximity to the wall-side cable outlets.

In one embodiment, the enclosure further includes an arcuate bearing surface associated with each cable outlet to prevent the cable exceeding a maximum bend radius. Integrating bearing surfaces with the enclosure in this way reduces the risk of damaging the fibre during the installation process as fibre is unspooled.

The sidewall of the drum portion may be configured to engage with detent means on an internal surface of the lid, such that when the lid is fastened to the base, the spool member is restrained against rotation. Once cable has been unspooled to the desired extent, the installer then needs only to attach the lid to the base to simultaneously complete assembly of the enclosure and prevent further unspooling, rather than having to separately retain the spool member in position.

The sidewall may have a plurality of grooves formed in its upper surface, and the detent means may include projections shaped to engage with one or more of the grooves. Preferably, the grooves extend substantially completely around the circumference of the upper surface, so that the detent means will engage with one or more grooves regardless of the precise angular position of the spool when the lid is attached.

In one embodiment, the drum portion includes a cable management channel around an internal surface of the sidewall.

The drum portion may have an internal space for accommodating the subscriber end connector and the carrier end connector. The internal space may include a pair of clips for retaining the two connectors. This may be particularly advantageous from a packaging point of view since the cable, including the connectors, may then be completely enclosed between the base and the lid.

In a further embodiment, the spool member may include means for mounting an extension spool to form a combined spool, such that an increased length of cable is accommodated by the combined spool. In situations where the hub is particularly distant from the subscriber and an increased length of cable is required, the cable can first be completely paid out from the extension spool, and then, following release of the extension spool from the spool member, further cable can be paid out from the spool member.

The means for mounting the extension spool may include at least one slot to receive one or more corresponding guides on the extension spool. The means for mounting the extension spool may also, or instead, include further slots or grooves to engage with one or more tabs on the extension spool.

In a second aspect, the invention provides a spool member for a surface-mountable enclosure for use with a fibre optic cable, the cable being terminated at one end by a subscriber end connector and at the other end by a carrier end connector, the surface-mountable enclosure including a base and a lid, the spool member including: a drum portion with an annular sidewall for spooling the cable.

Preferably, the sidewall of the drum portion is configured to engage with detent means on an internal surface of the lid, such that when the lid is fastened to the base to enclose the spool member, the spool member is restrained against rotation.

In a further aspect, the invention provides a kit of parts for a surface-mountable enclosure for use with a fibre optic cable, the cable being terminated at one end by a subscriber end connector and at the other end by a carrier end connector, the kit including:

a base;
a spool member which is mountable to the base for rotation relative thereto; and
a lid which is fastenable to the base to enclose the spool member;
wherein the spool member includes a drum portion with an annular sidewall for spooling the cable.

Preferably, the base includes a plurality of cable outlets, the carrier end connector being extractable to unspool a desired length of cable from the drum portion via one of the cable outlets. The cable outlets may face in at least two different directions for unspooling the desired length of cable in one of the directions.

In a yet further aspect of the present invention, there is provided a base for a surface-mountable enclosure for use with a fibre optic cable, the cable being terminated at one end by a subscriber end connector and at the other end by a carrier end connector, the surface-mountable enclosure including: a spool member including a drum portion with an annular sidewall for spooling the cable, and a lid which is fastenable to the base to enclose the spool member between the lid and the base, the base including:

a mounting point for the spool member to retain the spool member and allow it to rotate relative to the base to unspool cable from the drum portion.

Preferably, the base further includes a plurality of cable outlets, the carrier end connector being extractable to unspool a desired length of cable from the drum portion via one of the cable outlets. The plurality of cable outlets may face in at least two different directions for unspooling the desired length of cable in one of the directions.

Arcuate bearing surfaces may be associated with each of the cable outlets. The arcuate bearing surfaces may be formed integrally with the base.

In yet another aspect, the invention provides an extension spool for a surface-mountable enclosure for use with a fibre optic cable, the cable being terminated at one end by a subscriber end connector and at the other end by a carrier end connector, the surface-mountable enclosure including: a base; a spool member which is mountable to the base for rotation relative thereto; and a lid which is fastenable to the base to enclose the spool member; the spool member including a drum portion with an annular sidewall for spooling the cable; the extension spool including:
a cylindrical body for spooling the cable, and
means for mounting the extension spool to the spool member to form a combined spool.

The means for mounting the extension spool may include at least one guide to fit with a corresponding slot in the spool member. In one embodiment, the guide forms an interference fit with the slot.

The means for mounting the extension spool may include at least one tab to engage with a slot in the spool member.

The extension spool may include at least one cable management guide on its upper surface.

### BRIEF DESCRIPTION OF THE DRAWINGS

Embodiments of the present invention are hereafter described, by way of non-limiting example only, with reference to the accompanying drawings in which:

FIG. 1 is an exploded view of one embodiment of a surface-mountable enclosure;

FIG. 2 shows a top perspective view of the enclosure of FIG. 1, once assembled;

FIG. 3 is a top perspective view of a base for use with a surface-mountable enclosure according to one embodiment;

FIG. 4 is a side view of the base of FIG. 3;

FIG. 5 is a top plan view of the base of FIGS. 3 and 4;

FIG. 6 is an alternative view of part of the base of FIG. 3;

FIG. 7 is a top perspective view of one embodiment of a spool member according to the present invention, with a fibre-optic cable housed therein;

FIG. 8 is a side view of the spool member of FIG. 7;

FIG. 9 is a top plan view of the spool member of FIGS. 7 and 8, with the fibre-optic cable removed;

FIG. 10 shows the spool member of FIG. 7 retained within the base of FIGS. 3 to 5;

FIG. 11 is a bottom plan view of a lid for use with a surface-mountable enclosure;

FIG. 12 is a bottom perspective view of the lid of FIG. 11;

FIG. 13 is a top perspective view of an extension spool for use with a surface-mountable enclosure;

FIG. 14 is a bottom perspective view of the extension spool of FIG. 13;

FIG. 15 depicts the extension spool of FIGS. 13 and 14, positioned for connection to the spool member of FIGS. 7 to 9;

FIG. 16 shows the extension spool connected to the spool member; and

FIG. 17 shows an assembly in which the extension spool and spool member have a lid fastened thereto.

### DETAILED DESCRIPTION OF THE DRAWINGS

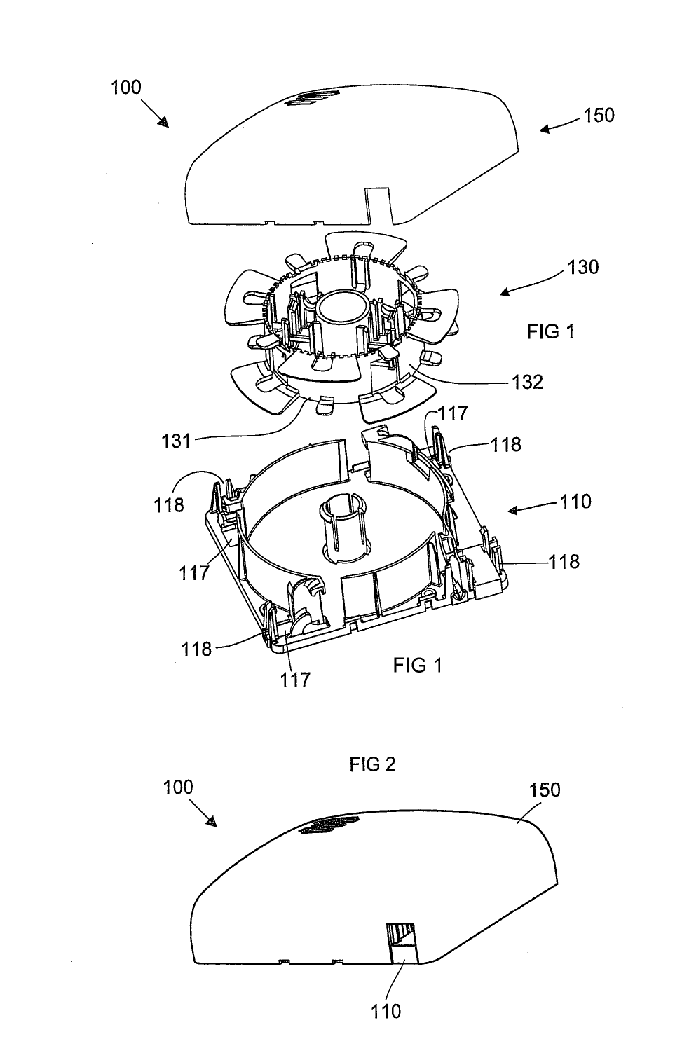

Referring initially to FIGS. 1 and 2, there is shown a surface-mountable enclosure 100 for use with a fibre-optic cable (not shown). The enclosure 100 is suitable for use with a fibre-optic cable which is terminated at one end with a subscriber-end connector and at the other end by a carrier-end connector. The subscriber-end and carrier-end connectors may be any suitable connector as known in the art, such as an SC or LC connector.

The enclosure 100 includes a base 110, a spool member 130, and a lid 150. When the enclosure is assembled, as shown in FIG. 2, the lid 150 is fastened to the base 110 (for example, by a snap fit, such as a cantilever snap fit as shown in the illustrated embodiment) such that the spool member 130 is enclosed between the lid 150 and the base 110. In assembly of the enclosure 100, the spool member 130 is mounted to the base 110, such that it can rotate relative to the base 110, in a manner which will be described in detail below.

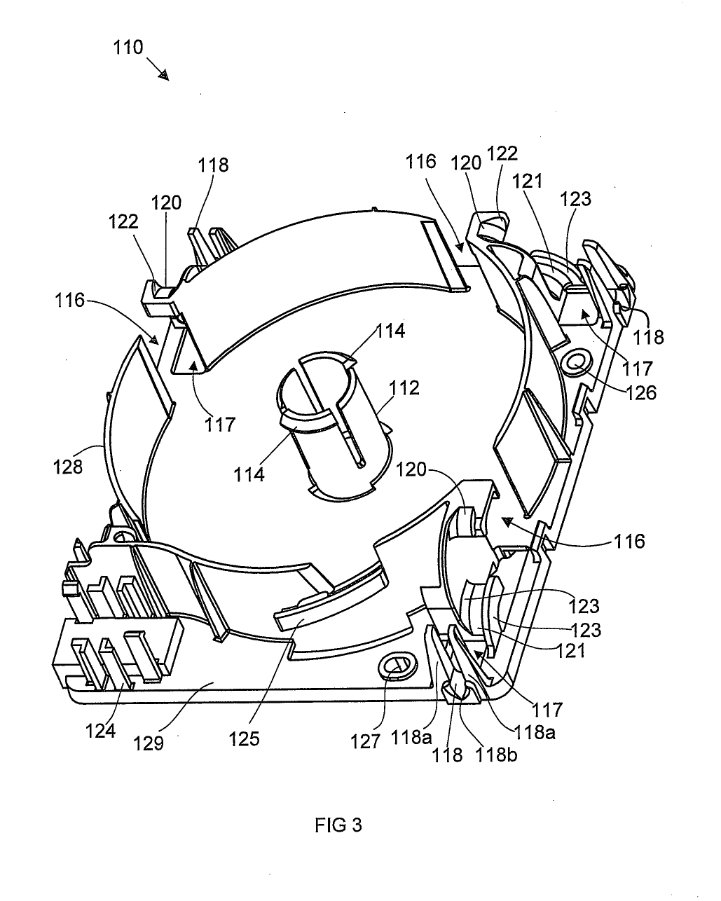

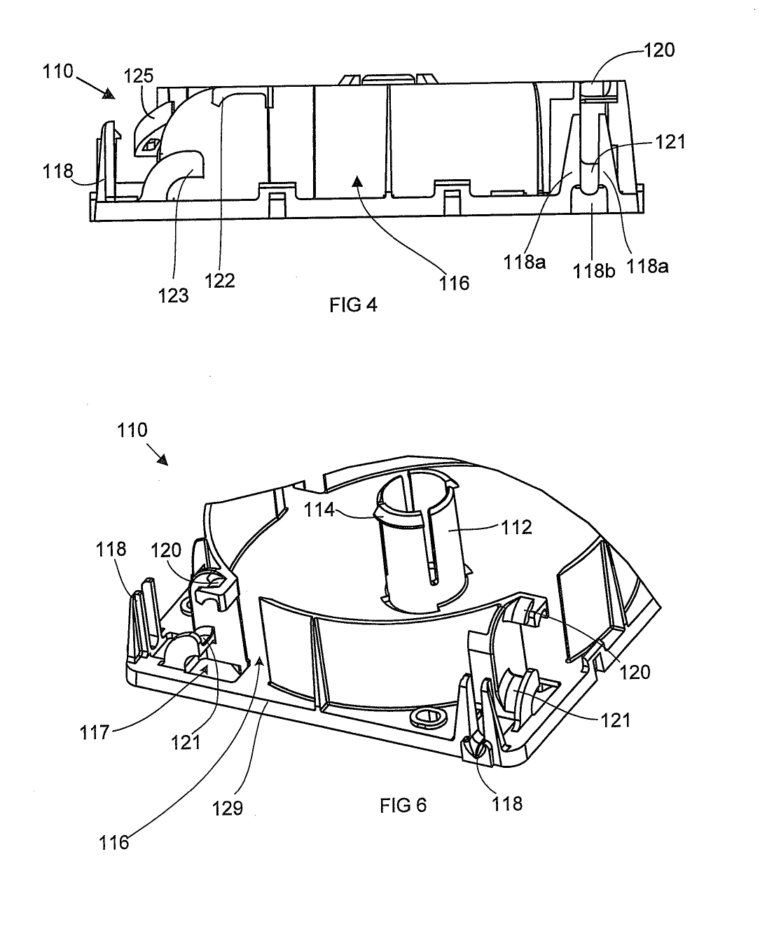

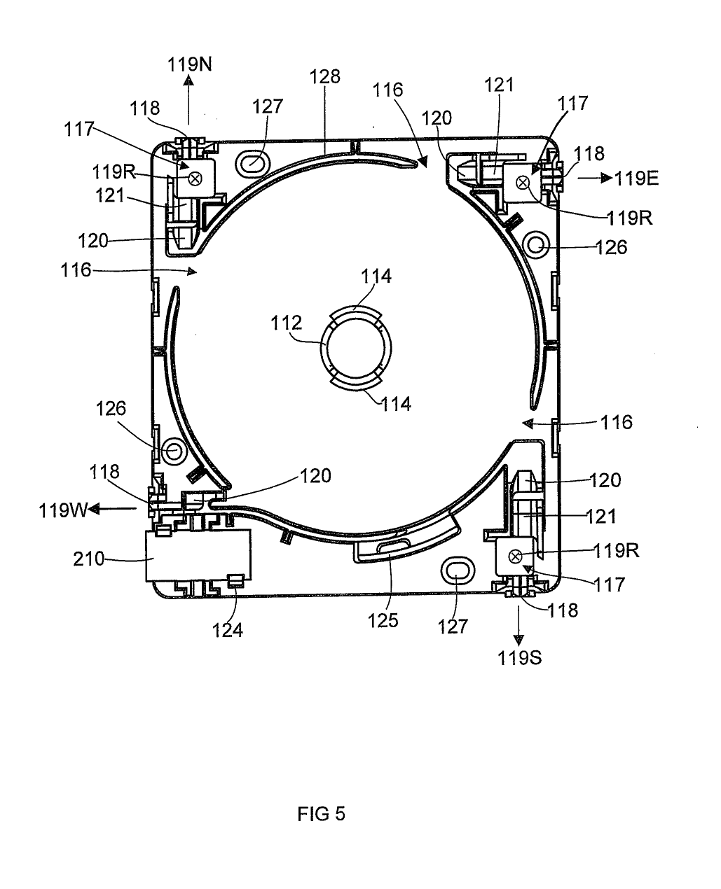

FIGS. 3 to 6 show the base 110 in more detail. The base includes a lower wall 129 and an annular sidewall 128 having a plurality of sidewall access apertures 116 formed therein. The lower wall 129 has a plurality of wall cavity cable outlets 117 formed therein. The sidewall access apertures 116 and the wall cavity cable outlets 117 are sized to allow the carrier-end connector to pass therethrough.

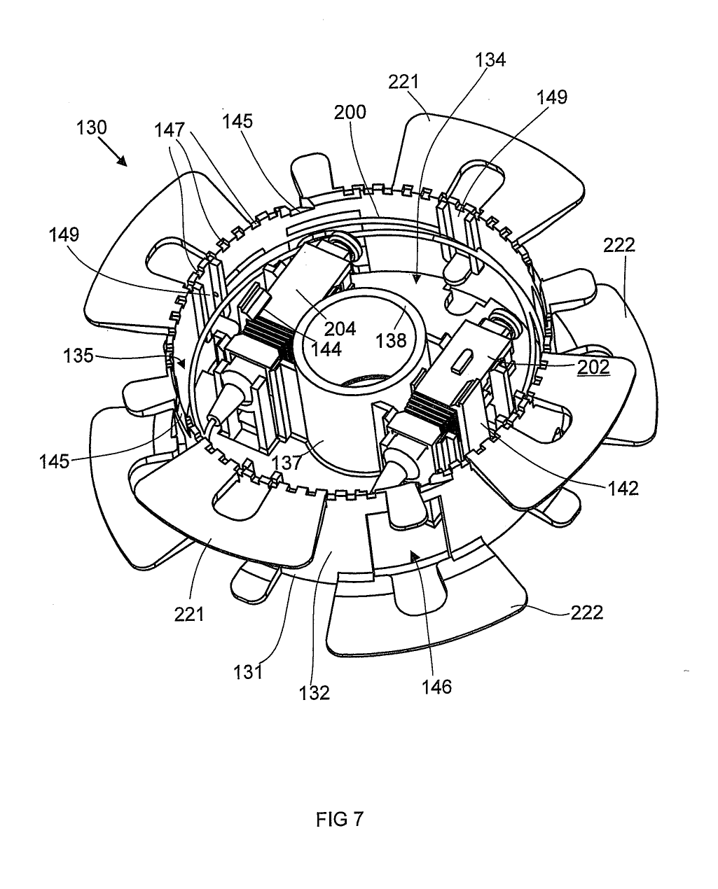

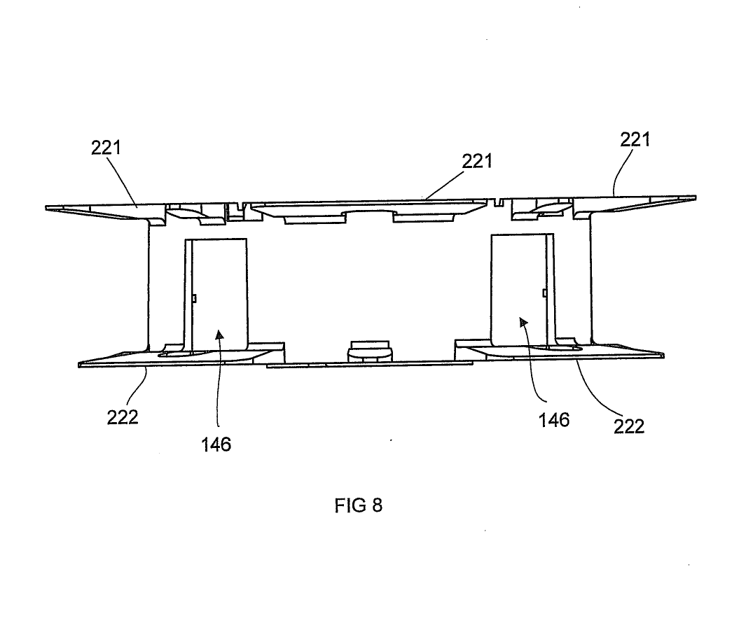

Referring now to FIGS. 7 and 8, there is shown the spool member 130 having a drum portion 131, upper wings 221 and lower wings 222. The drum portion has an annular sidewall 132 for spooling a fibre-optic cable 200 being terminated at one of its ends by a subscriber-end connector 202 and at the other of its ends by a carrier-end connector 204. For reasons of clarity, only the portion of the cable 200 which sits inside an internal space (generally indicated by 134) of the drum, is shown in FIG. 7. It will be understood that, in use, the majority of the fibre of cable 200 will be spooled around the outside surface of annular sidewall 132 (between upper 221 and lower 222 wings of the spool member 130) with a small amount near the respective ends being seated around a cable management channel 135 around the internal surface of the sidewall 132.

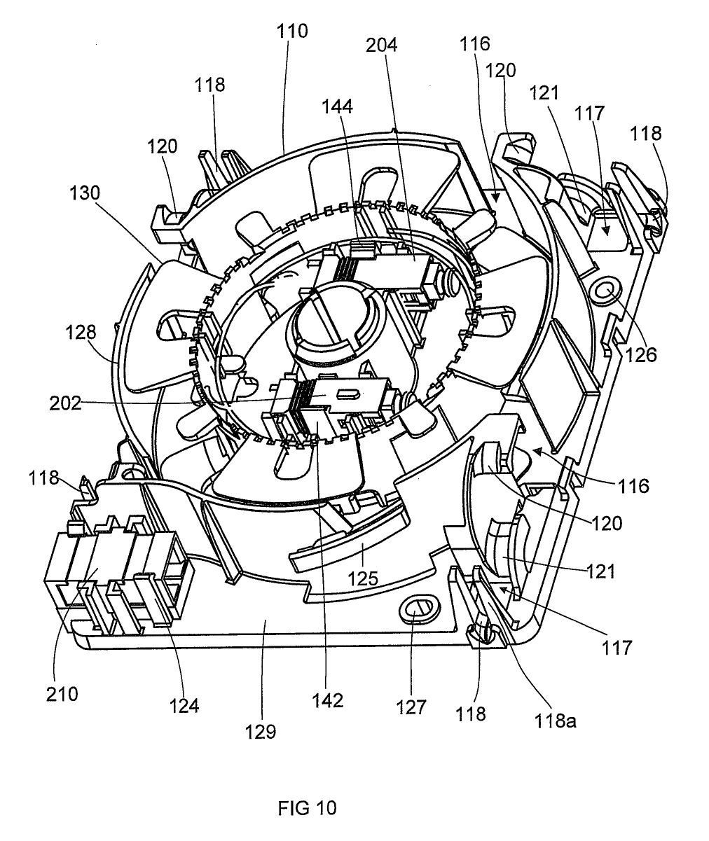

The spool member 130 includes a collar 137 which has an internal diameter which is sized such that the spool member 130 can be pushed onto flanges 114 of shaft 112 on the base 110, whereby the collar 137 forms a cantilever snap fit with shaft 112. Once the collar 137 is in place, flanges 114 bear against its upper surface 138 to retain the spool member 130 on the base 110 (FIG. 10). The shaft 112 has an external diameter which is slightly less than the internal diameter of collar 137, so that collar 137 forms a loose fit on the shaft 112 and the spool member 130 can rotate relatively freely with respect to the base 110 so as to allow cable to be unspooled.

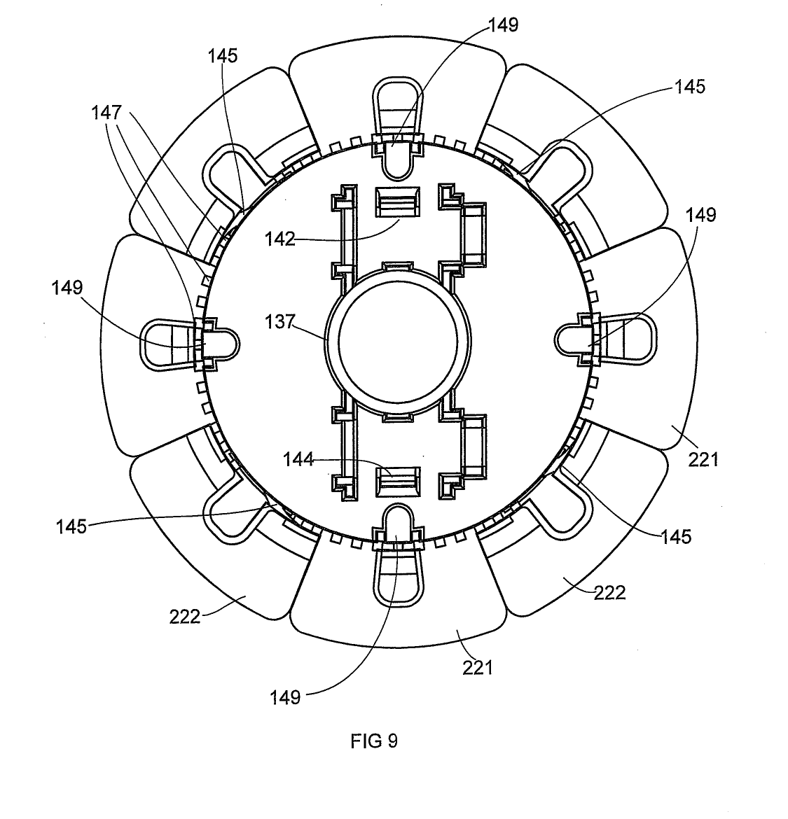

Conveniently, as shown best in FIGS. 7 and 9, the spool member 130 includes a pair of retaining clips 142 and 144 located either side of the collar 137 in the internal space 134, to respectively receive and retain subscriber-end connector 202 and carrier-end connector 204 in the internal space 134. The internal space 134 thereby acts as storage space for the connectors 202, 204. The subscriber-end connector 202 may be passed through one of the access apertures 146 formed in the sidewall 132 of the drum portion 131 so that it may be push-fitted into clip 142. After the fibre has been spooled on the drum 131, it may be passed through one of the access grooves 145 formed in the upper surface of sidewall 132, coiled around cable management channel 135, and the carrier-end connector 204 then clipped into retaining clip 144.

As best depicted in FIGS. 3 and 5, the base 110 includes a plurality of cable outlets 117 and 118 facing in at least two different directions. These include a plurality of wall-side cable outlets 118 which face in four different directions designated by reference numerals 119N, 119E, 119S and 119W. Thus, when the base 110 is mounted to a wall, cable may be unspooled via one of the four wall-side cable outlets 118 in one of the four different directions shown. The outlets also include three wall cavity cable outlets 117 through which the cable 200 (including carrier-end connector 204) can be passed so as to allow the cable 200 to be directed behind the base 110 of enclosure 100 and into a cavity formed in the wall. For convenience, the three wall cavity cable outlets 117 are located adjacent one of the four wall-side cable outlets 118.

Each of the wall-side cable outlets 118 includes a pair of arms 118a and a grooved lower section 118b, the surface of which is curved such that a fibre-optic cable passing over lower section 118b will not exceed its maximum bend radius.

The process of mounting an enclosure 100 to a wall and installing a fibre-optic connection will now be described, with initial reference to FIG. 10 in which the spool member 130 is shown mounted to the base 110.

Once the most suitable mount point has been chosen (which may depend, for example, on proximity to the network device which is to be connected to the fibre-optic enclosure and/or aesthetic considerations), the installer first decides whether the cable is to be run along the wall, or behind the wall. If the cable is to be run behind the wall then a cavity should be created in the wall and the base 110 mounted over the cavity. The base 110 and spool 130 may be fastened to the wall by any suitable means, preferably by screws which pass through apertures 126, 127 in the base.

If the connection to the hub is to be performed by running cable along a wall, the installer chooses one of the four directions 119N, 119S, 119W, 119E (FIG. 5) associated with wall-side cable outlets 118. The carrier-end connector 204 is then unclipped from retaining clip 144 and uncoiled from cable management channel 135. Carrier-end connector 204 may be passed through sidewall aperture 116 and the cable 200 then placed between the arms 118a of the chosen outlet 118. Alternatively, the connector 204 may be passed over an upper arcuate bearing surface 120 associated with the chosen outlet 118 and the cable 200 then placed between the arms 118a. Once this is done, the carrier-end connector 204 can be pulled to unspool further cable 200, with the cable passing over the arcuate bearing surface 120 and/or grooved lower section 118b such that the maximum bend radius of the cable is not exceeded while the cable is being unspooled. Once a sufficient length of cable has been unspooled, the carrier-end connector 204 is connected to the hub.

If the connection to the hub is to be performed by running cable behind the wall, the installer chooses one of the three wall cavity cable outlets 117. The carrier-end connector 204 is then unclipped from retaining clip 144 and uncoiled from cable management channel 135. Carrier-end connector 204 may be passed through sidewall aperture 116 then through wall cavity outlet 117 via its associated lower arcuate bearing surface 121, which in similar fashion to upper arcuate bearing surface 120, is configured to prevent the cable 200 exceeding its maximum bend radius. Alternatively, the connector 204 may be passed over the upper arcuate bearing surface 120 associated with the wall cavity outlet 117 and the carrier-end connector 204 then passed through wall cavity outlet 117 and into the wall cavity in the direction depicted by reference numeral 119R. Once this is done, the carrier-end connector 204 can be pulled to unspool further cable 200 behind the wall, with the cable passing over either upper arcuate bearing surface 120 or lower arcuate bearing surface 121 such that the maximum bend radius of the cable is not exceeded while the cable is being unspooled.

As shown in FIGS. 3 to 6, upper arcuate bearing surfaces 120 sit between inclined walls 122, and lower arcuate bearing surfaces 121 between inclined walls 123, such that the cable 200 will tend to stay within a channel defined by a bearing surface and its associated inclined walls as it is unspooled from the drum 131. The bearing surfaces 120, 121 and associated inclined walls 122, 123 are preferably formed integrally with the base 110 such that the base 110 can be formed as a single moulded component.

As an alternative to the base configuration shown in FIGS. 3 to 6, the upper arcuate bearing surfaces 120 may be curved in the opposite sense, so that when running cable along a wall, the cable may be passed along the underside of an upper arcuate bearing surface 120 and then through wall-side outlet 118 to pay out cable from the spool member 130. However, it has been found that allowing cable to pass along bearing surfaces 120 as shown in FIGS. 3 to 6 provides for more efficient unspooling of the cable.

To provide the subscriber-end connection, an adapter 210 of known type and suited to receive the subscriber-end connector 202 is inserted into adapter housing 124 on the base 110, subscriber-end connector 202 is unclipped from retaining clip 142 and passed through one of the apertures 146 in the drum 131, and then inserted into adapter 210. Cable at the subscriber end is passed along channel 125 adjacent the sidewall 128 of the base prior to securing the subscriber-end connector 202 in the adapter 210.

Once the desired length of cable 200 (i.e., sufficient to reach the hub) has been unspooled, and the carrier-end connector and subscriber-end connector are both in place, installation is completed by affixing the lid 150 to the base 110.

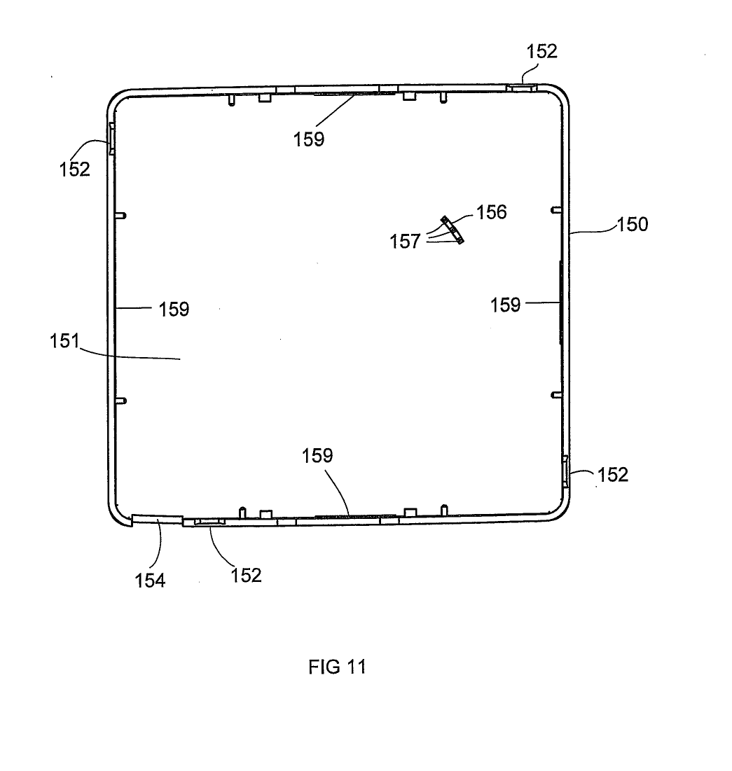

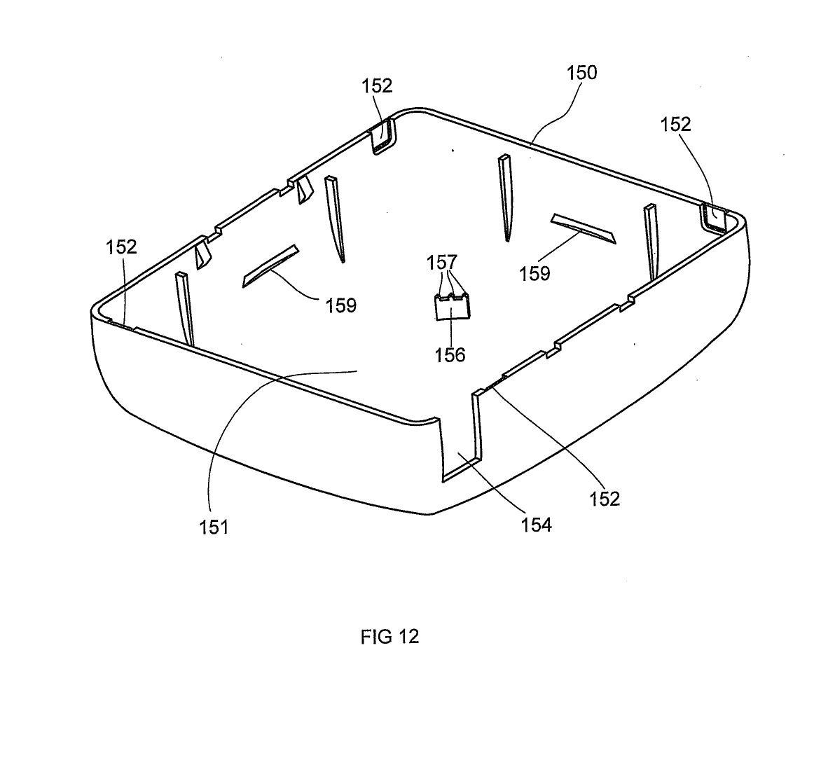

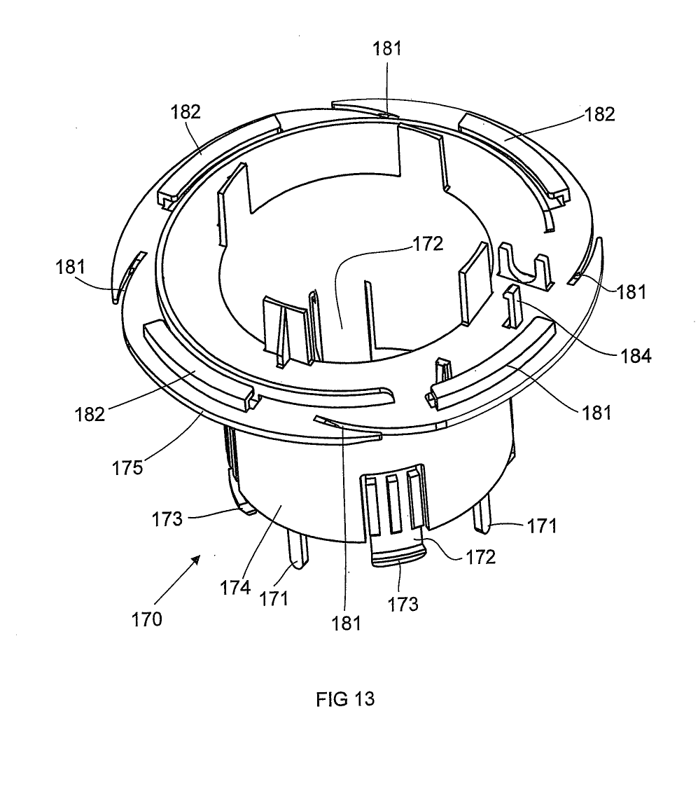

As shown in FIGS. 11 and 12, the lid 150 includes detent means 156 on its internal surface 151. The detent means 156 includes projections in the form of a plurality of teeth 157 and is located at a distance from the centre of the internal surface 151 which corresponds to the radius of the drum 131 of spool member 130. This is so that, when the lid 150 is fastened to the base 110, the teeth 157 of detent means 156 will engage with the sidewall 132 of the drum portion 131, thereby to restrain the spool member 130 against rotation about the shaft 112 of base 110. The spool 130 is thus interlocked with the lid 150 and cannot rotate and release any further cable.

The sidewall 132 is configured to engage with the detent means 156 via a plurality of grooves 147 (FIGS. 7 and 9) formed in an upper surface of the sidewall 132. Because the grooves 147 extend substantially completely around the circumference of the upper surface (apart from in the locations of cable access grooves 145), the detent means 156 will be able to engage the sidewall 132 regardless of the angular position of the spool member 130.

The lid 150 includes a subscriber access aperture 154 and a plurality of breakout or tear-out sections 152. When fastening the lid 150 to the base 110, the subscriber access aperture 154 is positioned over the adapter 210 (which holds subscriber-end connector 202). The breakout sections 152 correspond to the positions of wall-side cable outlets 118, so that depending on which outlet 118 has been chosen by the installer, the appropriate breakout section 152 should be removed (prior to affixing the lid) in order to leave space between the lid 150 and the base 110 for cable to exit the enclosure 100. If a wall cavity outlet 117 is used, then of course it will not be necessary to remove a breakout section 152.

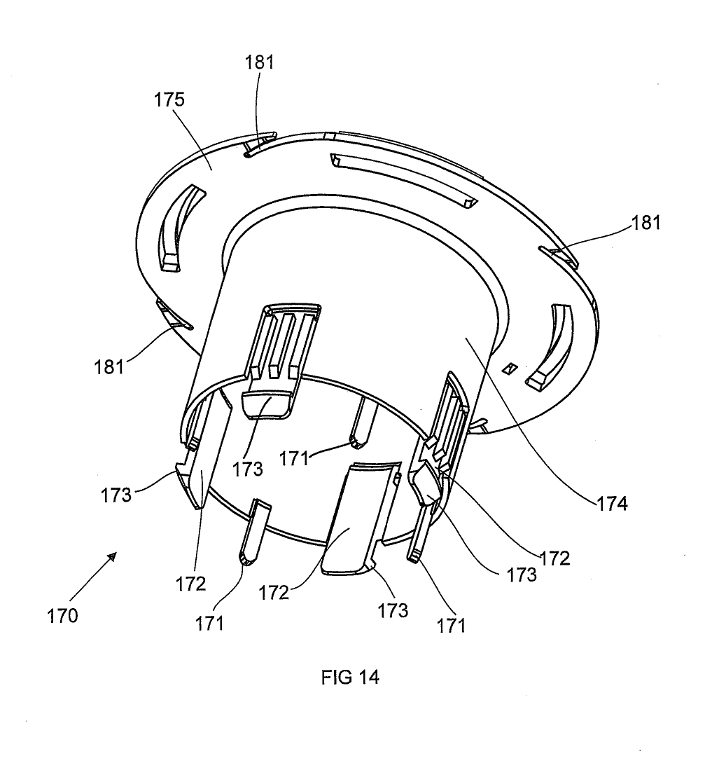

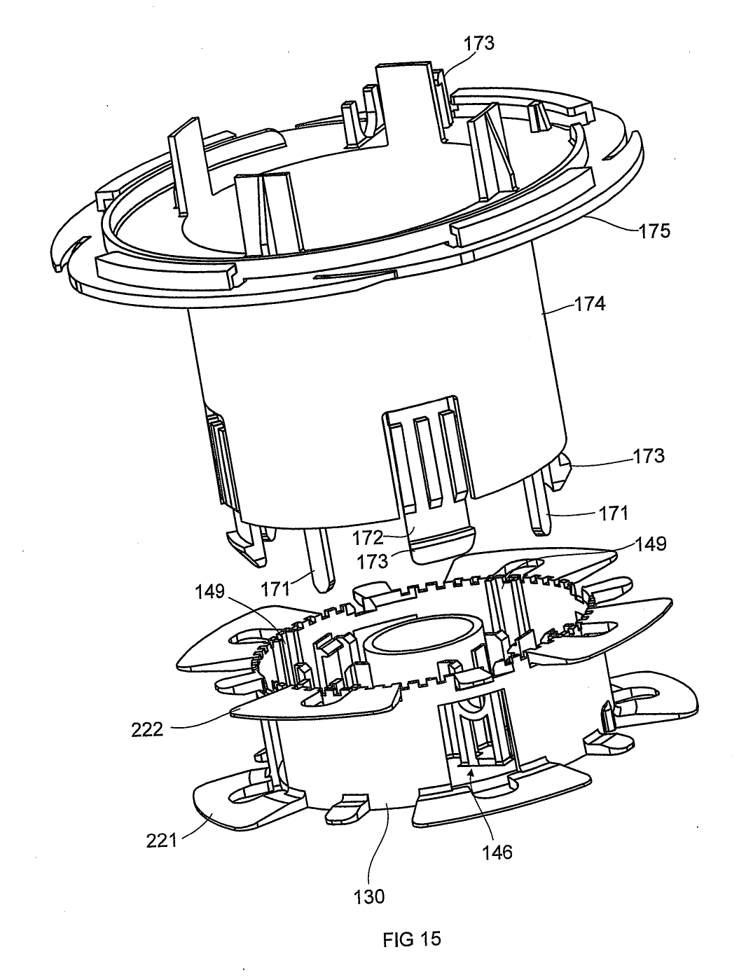

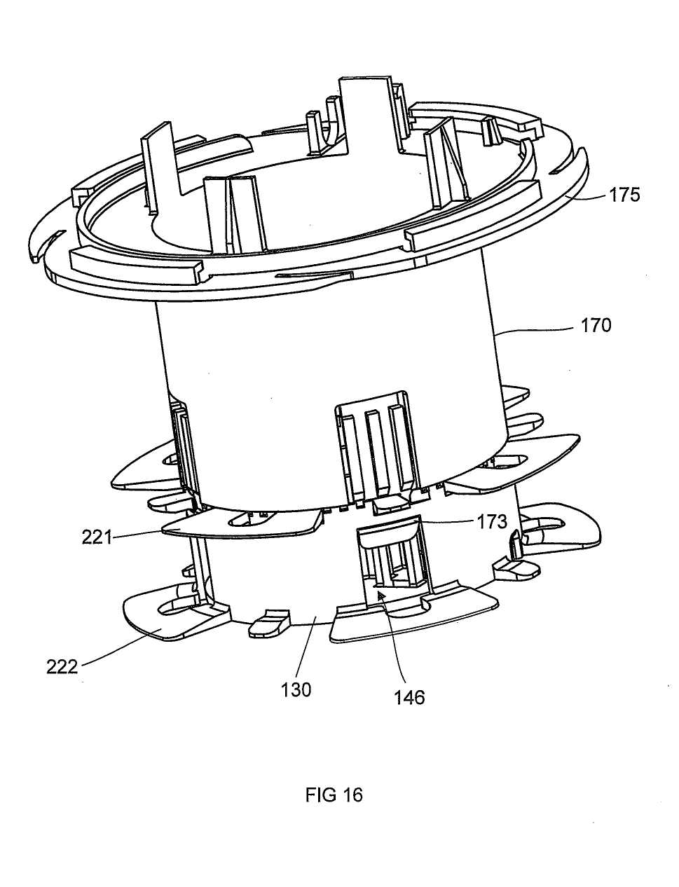

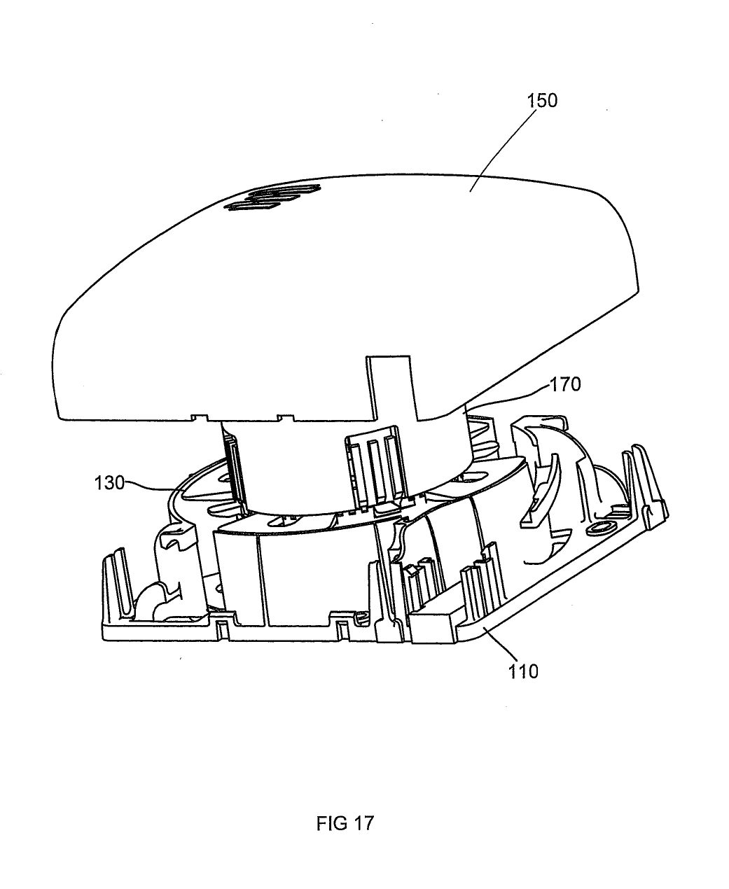

Turning now to FIGS. 13 to 17, there is shown an optional extension spool 170 for use with the enclosure 100 of FIGS. 1 to 12. The extension spool 170 includes a substantially cylindrical body 174 about which cable 200 can be spooled, and an upper portion 175 having a lip extending from the cylindrical body 174. A lower portion of the cylindrical body 174 has a plurality of assembly guides 171 shaped to fit within corresponding slots 149 in spool member 130. In some embodiments, the assembly guides 171 may form an interference fit with slots 149 such that extension spool 170 is retained on spool 130. In the embodiment shown in FIGS. 13 to 17, the extension spool 170 includes a plurality of tabs 172 each having a flange 173, such that when the extension spool 170 is pushed onto spool member 130 (using assembly guides 171 to properly locate the extension spool 170), a cantilever snap fit is formed as the flanges 173 engage with a surface of the access apertures 146 of the drum 131. FIG. 16 shows the extension spool 170 securely fitted to the spool member 130.

The use of an extension spool 170 permits a greater length of cable to be spooled. The extension spool 170 may be made as large as desired in order to accommodate the desired length of cable. When the cable is spooled on the combined spool member 130 and extension spool 170 (between lower and upper wings 222, 221 and between upper wings 221 and the lip of upper portion 175), the carrier end of the cable may be threaded through one of the four slots 181 in the upper portion of the extension spool 170, and then passed around a series of cable slack management guides 182. Once this is done, the carrier-end connector 204 can be retained by a connector clip 184 on the extension spool 170.

When installing cable, the carrier-end connector 204 is removed from connector clip 184, and cable paid out from the extension spool 170 until no further cable remains on the extension spool 170. The extension spool 170 is then unclipped from the spool member 130, and further cable may then be paid out from the spool member 130 as previously described.

For packaging purposes, it may be desirable to provide means for attaching the lid 150 to the extension spool 170, as shown in FIG. 17. This may be done by providing protrusions or grooves 159 on the inside of lid 150 which are configured to engage with, for example, the lip of the upper portion 175 of the extension spool by a snap fit. It will be appreciated that any number of other ways of releasably fastening the lid 150 to the extension spool 170 are also possible.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

### LISTING OF PARTS

100 enclosure
110 base
112 shaft (of base)
114 flange (of shaft)
116 sidewall access apertures
117 lower wall access apertures
118 wall-side cable outlet
118a arm of wall-side cable outlet
118b grooved lower section of wall-side cable outlet
119N direction of cable payout (along wall)
119S direction of cable payout (along wall)
119W direction of cable payout (along wall)
119E direction of cable payout (along wall)
119R direction of cable payout (behind wall)
120 upper arcuate bearing surface
121 lower arcuate bearing surface
122 inclined wall (of upper arcuate bearing surface)
123 inclined wall (of lower arcuate bearing surface)
124 adapter housing
125 channel for subscriber end of cable
126 screw aperture
127 screw aperture
128 annular sidewall (of base)
129 lower wall (of base)
130 spool member
131 drum portion (of spool member)
132 annular sidewall (of drum portion)
134 internal space (of drum portion)
135 cable management channel (of drum portion)
137 collar
138 upper surface of collar
142 retaining clip (for subscriber-end connector)
144 retaining clip (for carrier-end connector)
145 cable access grooves of drum sidewall
146 access apertures of drum
147 grooves of drum sidewall
149 slots (to receive extension spool assembly guides)
150 lid
151 internal surface (of lid)
152 breakout section (of lid)
154 subscriber access aperture
156 detent means
157 teeth (of detent means)
159 protrusions (for fastening lid to extension spool)
170 extension spool
171 assembly guide (of extension spool)
172 tab (of extension spool)
173 flange (of tab)
174 cylindrical body (of extension spool)
175 upper portion of extension spool
181 cable slots of extension spool
182 cable management guides of extension spool
184 connector clip for carrier-end connector
200 fibre-optic cable
202 subscriber-end connector
204 carrier-end connector
210 adapter for subscriber-end connector
221 upper wings (of spool member)
222 lower wings (of spool member)
310 alternative base
320 upper arcuate bearing surface (of alternative base)
322 wall of upper arcuate bearing surface

1. A surface-mountable enclosure for use with a fibre optic cable, the cable being terminated at one end by a subscriber end connector and at the other end by a carrier end connector, the surface-mountable enclosure including:
a base;
a spool member which is mountable to the base for rotation relative thereto; and
a lid which is fastenable to the base to enclose the spool member;
wherein the spool member includes a drum portion with an annular sidewall for spooling the cable.

2. A surface-mountable enclosure according to claim 1, wherein the base includes a plurality of cable outlets, the carrier end connector being extractable to unspool a desired length of cable from the drum portion via one of the cable outlets.

3. A surface-mountable enclosure according to claim 2 wherein the plurality of cable outlets faces in at least two different directions for unspooling the desired length of cable in one of the at least two different directions.

4. A surface-mountable enclosure according to claim 3, wherein the plurality of cable outlets includes a plurality of wall-side cable outlets to allow the cable to be directed in one of the at least two different directions along a wall to which the enclosure is mounted.

5. A surface-mountable enclosure according to claim 3, wherein the plurality of cable outlets includes a plurality of wall cavity cable outlets to allow the cable to be directed behind the enclosure and into a wall cavity.

6. A surface-mountable enclosure according to claim 2, further including an arcuate bearing surface associated with each of the cable outlets to prevent the cable exceeding a maximum bend radius.

7. A surface-mountable enclosure according to claim 6, wherein the arcuate bearing surfaces are formed integrally with the base.

8. A surface-mountable enclosure according to claim 4, including four wall-side cable outlets facing in four different directions.

9. A surface-mountable enclosure according to any one of the preceding claims, wherein the sidewall of the drum portion is configured to engage with detent means on an internal surface of the lid, such that when the lid is fastened to the base, the spool member is restrained against rotation.

10. A surface-mountable enclosure according to claim 9, wherein the sidewall has a plurality of grooves formed in its upper surface and the detent means includes projections shaped to engage with one or more of the grooves.

11. A surface-mountable enclosure according to claim 10, wherein the grooves extend substantially completely around the circumference of the upper surface.

12. A surface-mountable enclosure according claim 1, wherein the drum portion includes a cable management channel around an internal surface of the sidewall.

13. A surface-mountable enclosure according to claim 1, wherein the drum portion has an internal space for accommodating the subscriber end connector and the carrier end connector.

14. A surface-mountable enclosure according to claim 12, wherein the internal space includes a pair of clips for retaining the subscriber end connector and the carrier end connector.

15. A surface-mountable enclosure according to claim 1, wherein the spool member includes means for mounting an extension spool to form a combined spool, such that an increased length of cable is accommodated by the combined spool.

16. A spool member for a surface-mountable enclosure for use with a fibre optic cable, the cable being terminated at one end by a subscriber end connector and at the other end by a carrier end connector, the surface-mountable enclosure including a base and a lid, the spool member including:
a drum portion with an annular sidewall for spooling the cable.

17. A spool member according to claim 16, wherein the sidewall of the drum portion is configured to engage with detent means on an internal surface of the lid, such that when the lid is fastened to the base to enclose the spool member, the spool member is restrained against rotation.

18. A spool member according to claim 17, wherein the sidewall has a plurality of grooves formed in its upper surface and the detent means includes projections shaped to engage with one or more of the grooves.

19. A spool member according to claim 18, wherein the grooves extend substantially completely around the circumference of the upper surface.

20. A spool member according to claim 17, wherein the drum portion includes means for mounting an extension spool to form a combined spool, such that an increased length of cable is accommodated by the combined spool.

21. A kit of parts for a surface-mountable enclosure for use with a fibre optic cable, the cable being terminated at one end by a subscriber end connector and at the other end by a carrier end connector, the kit including:
a base;
a spool member which is mountable to the base for rotation relative thereto; and
a lid which is fastenable to the base to enclose the spool member;
wherein the spool member includes a drum portion with an annular sidewall for spooling the cable.

22. A kit according to claim 21, wherein the base includes a plurality of cable outlets, the carrier end connector being extractable to unspool a desired length of cable from the drum portion via one of the cable outlets.

23. A kit according to claim 22, wherein the plurality of cable outlets faces in at least two different directions for unspooling the desired length of cable in one of the at least two different directions.

24. A kit according to claim 21, further including an extension spool which is mountable to the drum portion of the spool member to form a combined spool.

25. A kit according to claim 24, wherein the extension spool includes at least one cable management guide on its upper surface.

26. A base for a surface-mountable enclosure for use with a fibre optic cable, the cable being terminated at one end by a subscriber end connector and at the other end by a carrier end connector, the surface-mountable enclosure including: a spool member including a drum portion with an annular sidewall for spooling the cable which is fastenable to the base to enclose the spool member between the lid and the base, the base including:
a mounting point for the spool member to retain the spool member and allow it to rotate relative to the base to unspool cable from the drum portion.

27. A base according to claim 26, further including a plurality of cable outlets, the carrier end connector being extractable to unspool a desired length of cable from the drum portion via one of the cable outlets.

28. A base according to claim 27, wherein the plurality of cable outlets faces in at least two different directions for unspooling the desired length of cable in one of the at least two different directions.

29. A base according to claim 27, wherein arcuate bearing surfaces are associated with each of the cable outlets.

30. A base according to claim 29, wherein the arcuate bearing surfaces are formed integrally with the base.

31. An extension spool for a surface-mountable enclosure for use with a fibre optic cable, the cable being terminated at one end by a subscriber end connector and at the other end by a carrier end connector, the surface-mountable enclosure including: a base; a spool member which is mountable to the base for rotation relative thereto; and a lid which is fastenable to the base to enclose the spool member; the spool member including a drum portion with an annular sidewall for spooling the cable; the extension spool including:
a cylindrical body for spooling the cable, and
means for mounting the extension spool to the spool member to form a combined spool.

32. An extension spool according to claim 31, wherein the means for mounting the extension spool includes at least one guide to fit with a corresponding slot in the spool member.

33. An extension spool according to claim 32, wherein the guide forms an interference fit with the slot.

34. An extension spool according to claim 31, further including at least one cable management guide on its upper surface.

35. An extension spool according to claim 31, wherein the means for mounting the extension spool includes at least one tab to engage with a slot in the spool member.
